(19) United States
(12) Patent Application Publication
(10) Pub. No.: US 2019/0212219 A1
(43) Pub. Date: Jul. 11, 2019

(54) Protective device for a vacuum measuring cell

(71) Applicant: Plöchinger Patent, Freinberg (AT)

(72) Inventors: Heinz Plöchinger, Freinberg (AT); Christian Magnus Plöchinger, Freinberg (AT)

(73) Assignee: Plöchinger Patent, Freinberg (AT)

(21) Appl. No.: 15/865,616

(22) Filed: Jan. 9, 2018

(51) Int. Cl. G01L 19/06; G01L 9/00

(52) U.S. Cl. CPC G01L 19/0627; G01L 9/0072

(57) ABSTRACT

To prevent negative influences of a measuring gas on vacuum sensor elements a protective device including one or more deflection elements made of wire, tape, or tube is inserted between the gas port or a vacuum measuring cell and the sensor element or sensor elements therein. The deflection element may be a spiral-shaped member and may be fabricated and deposited by laser melting from pure metal or an alloy on an inlet or outlet plate. The deflection element may react with the sample gas or its constituents. The deflection element extends the path of the incoming measurement gas to the sensor element and deflects the flow direction, whereby contaminant particles carried with the gas are deposited on the deflection element.

### TECHNICAL FIELD

The present invention relates to a device for protecting vacuum measuring cells against the influence of damaging measuring fluids.

### BACKGROUND

Vacuum measuring cells can be negatively affected by contaminants which may be present in a measuring gas.

U.S. Pat. No. 7,443,169 describes a shield arrangement for a vacuum measurement cell. It comprises a tubular shield housing surrounding a shield. The housing has an outlet opening for a connection to a vacuum measurement cell and has a connection opening for a connection with the object space to be measured. The shield is arranged between the two openings and in form of a screw shield with spiral convolutions.

US patent application publication US2016069764 by the same applicant describes a pressure sensor for measuring a fluid pressure which includes a capacitance gauge with a small measuring volume and a simple particle filter (mesh). US2016069764 is hereby incorporated by reference.

An object of the present disclosure is to provide a device for protecting a vacuum measuring cell, i.e. to provide a device which prevents or significantly reduces negative impact of a measuring gas on vacuum sensor elements.

### SUMMARY

To reduce or prevent negative influences of a measuring fluid such as a gas on a vacuum sensor a protective device is provided. The protective device includes at least one deflection element, which may be a spiral-shaped member. The deflection element is provided between an inlet plate and an outlet plate. The deflection element forms a maze between a gas sample port of a vacuum measuring cell proximal to an inlet opening in the inlet plate and preferably two outlet openings in the outlet plate facing the sensor element or the sensor elements arranged within the vacuum measuring cell. The deflection element may be a spiral-shaped member and may be a flat coil made of wire, tape, or tube of a particular material. Instead of being a separately inserted element, the deflection element may be fabricated and deposited by laser melting a pure metal or a metal alloy on the inlet or outlet plate.

The deflection element defines a flow-path of the incoming measurement gas from the sample port to the sensor element. For example, a spiral-shaped deflection element extends the flow path of the incoming measurement gas to the sensor element and deflects the flow direction, whereby particles entrained with the gas are deposited on the spiral-shaped member. The flow path is preferably at least three times longer than a lateral distance of the inlet opening and outlet opening of the device. The absolute sum of all directional changes of a gas following the flow path, irrespective of the direction of the directional change, is referred to as the absolute angular flow deflection and is preferably larger than 540°.

Optionally, the deflection element can react in a desired manner with the sample gas or its constituents. The large wire, tape, tube or wall surface of the spiral-shaped member then provides an incentive for a desired reaction. Depending on the chemical composition of the measuring gas, the spiral-shaped member may for example be made of molybdenum, nickel, tungsten, metal alloys, plastics, or ceramics. Alternatively or additionally, the spiral-shaped member may be coated with a material based on aluminum oxide, calcium fluoride, etc. The number of turns of the spiral can be matched to the sample gas.

### BRIEF DESCRIPTION OF THE DRAWINGS

FIG. 1a is a horizontal cross-sectional view through a protective device for a vacuum measuring cell.

FIG. 1b is a bottom view of the protective device as in FIG. 1a.

FIG. 1c is a vertical cross-sectional view of the protective device as in FIG. 1a.

FIG. 1d is a vertical cross-sectional view of an alternative protective device for a vacuum measuring cell.

FIG. 2 is a cross sectional view showing the protective device as in FIG. 1d arranged within a vacuum measuring cell.

FIG. 3a is a horizontal cross-sectional view through an alternative embodiment of a protective device.

FIG. 3b is a bottom view of the device as in FIG. 3a.

FIG. 4a is a horizontal cross-sectional view through yet another embodiment of a protective device.

FIG. 4b is a bottom view of the device as in FIG. 4a.

### DETAILED DESCRIPTION

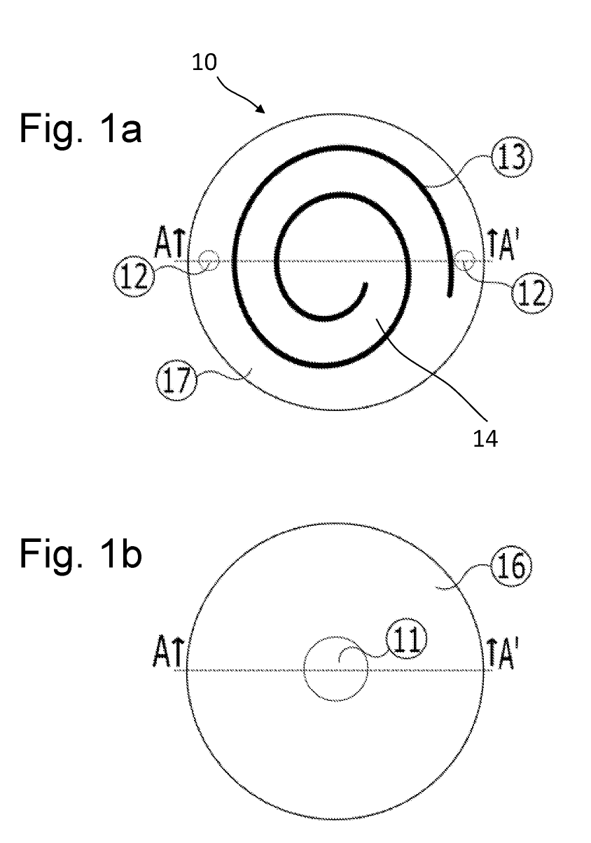

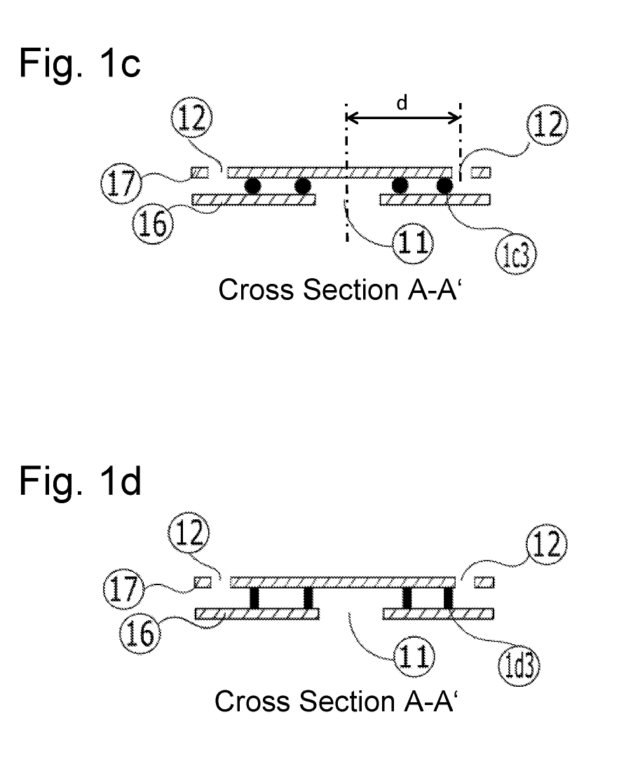

Referring to FIG. 1a-d, an exemplary protective device 10 comprises an inlet plate 16 as and an outlet plate 17. The inlet plate 16 and the outlet plate 17 may be disk-shaped, arranged in parallel planes, and stacked coaxially on top of each other. The inlet plate 16 comprises a centrally arranged inlet opening 11. The inlet opening 11 may be in flow communication with a vacuum port of a vacuum measuring cell (device) and face a fluid container the pressure in which is to be measured. The outlet plate 17 comprises an outlet opening 12. The outlet opening 12 is laterally spaced apart from the inlet opening 11 by a lateral distance d. The outlet opening may be in flow communication with a pressure sensing element arranged within the vacuum measuring cell. As shown, the outlet plate 17 may comprise a plurality of circumferentially distributed outlet openings 12.

A spiral-shaped deflection element 13 is arranged between the inlet plate 16 and the outlet plate 17. The deflection element 13 forms a maze 14 through which fluid can flow between the inlet opening 11 to the outlet opening 12. Fluid can flow from the outlet opening 12 to the inlet opening 11 or in opposite direction from the inlet opening 11 to the outlet opening 12, i.e. a flow path through the maze 13 is bidirectional.

The flow path through the maze 14 has a flow path length fl which is longer than the lateral distance d between the inlet opening 11 and the outlet opening 12. In particular, the deflection element 13 may be shaped such that that ratio fl/d>3. Alternatively, the deflection element 13 may be selected so that fl/d>5, fl/d>10 or even fl/d>20. The spiral shaped deflection element 13 as shown in FIG. 1a is selected such that the ratio of fl/d is approximately 10.

The deflection element 13 may be an elongated member with a circular or rectangular cross section. The deflection element 13 is so tightly arranged between the inlet plate 16 and the outlet plate 17 that fluid cannot flow across (above or below) but only along the deflection element 13. The flow path extends in a plane parallel to and arranged between the inlet plate 16 and the outlet plate 17. The deflection element 13 forms a maze 14 and serves to guide a measuring gas, which flows through an inlet opening 11 in the inlet plate 16 from a measuring space into the maze 14 and passes through the outlet openings 12 in the outlet plate 17 to the sensor elements.

The deflection element 13 may be made of pure metal, alloy, plastic, ceramic or a mixture of these materials. The deflection element 13 may be a wire, tape, or tube which forms a flat coil and is interposed between the inlet plate 16 and the outlet plate 17. The deflection element 13 may alternatively be formed on or connected to the inlet plate 16, the outlet plate 17, or both the inlet plate 16 and the outlet plate 17. Alternatively, the deflection element 13 may consist of a wall made or deposited by laser melting or laser sintering on the inlet plate 16, on the outlet plate 17, or on both the inlet plate 16 and the outlet plate 17.

FIG. 1c and FIG. 1d show a cross-section through a protective device with the inlet opening 11 in the inlet plate 16 and the outlet openings 12 in the outlet plate 17. FIG. 1c shows an arrangement with a spiral-shaped member 1c3 formed from a round wire.

In an alternative embodiment shown in FIG. 1d, the spiral-shaped member 1d3 has a rectangular cross section and is formed from a band or produced by laser fusion.

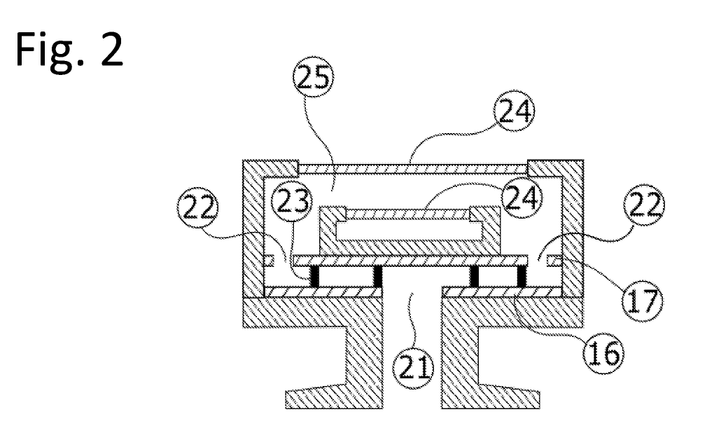

FIG. 2 illustrates an exemplary application of the protective device. From a gas port 21, a measuring gas flows into and through the protective device and through the outlet openings 22 into or out of the measuring space 25. The spiral-shaped deflection element 23 in this exemplary application is formed of sheet metal or produced by laser melting or laser sintering. Fluid pressure in the measuring space 25, and thereby the pressure in a vacuum container (not shown) attached to the gas port 21, is measured by two measuring membranes 24. A detailed description of a sensor for measuring a fluid pressure, in particular a vacuum pressure, that may be used in combination with the protective device is disclosed in US patent application publication No. 2016/0069764 which is hereby incorporated by reference thereto in its entirety.

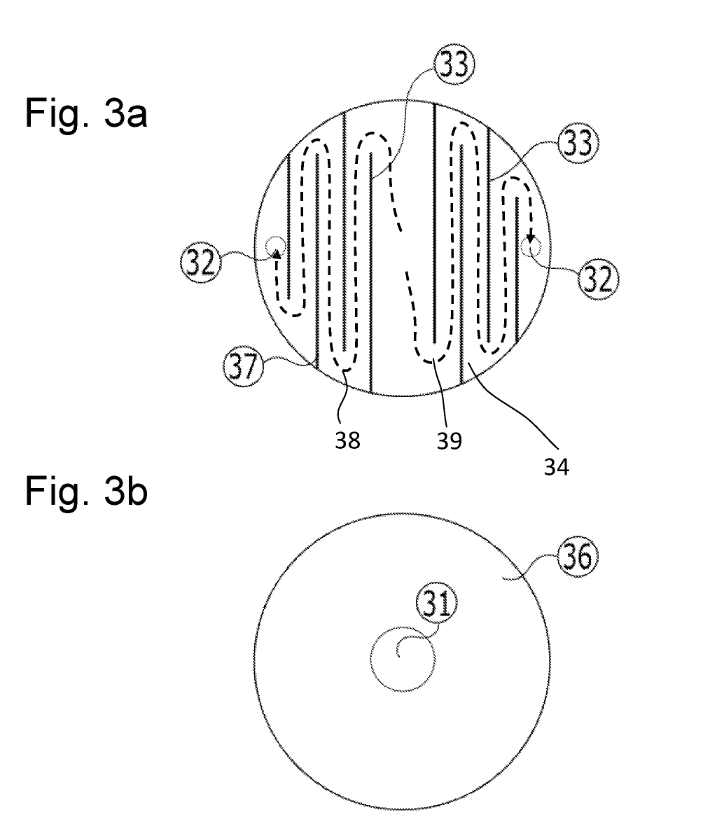

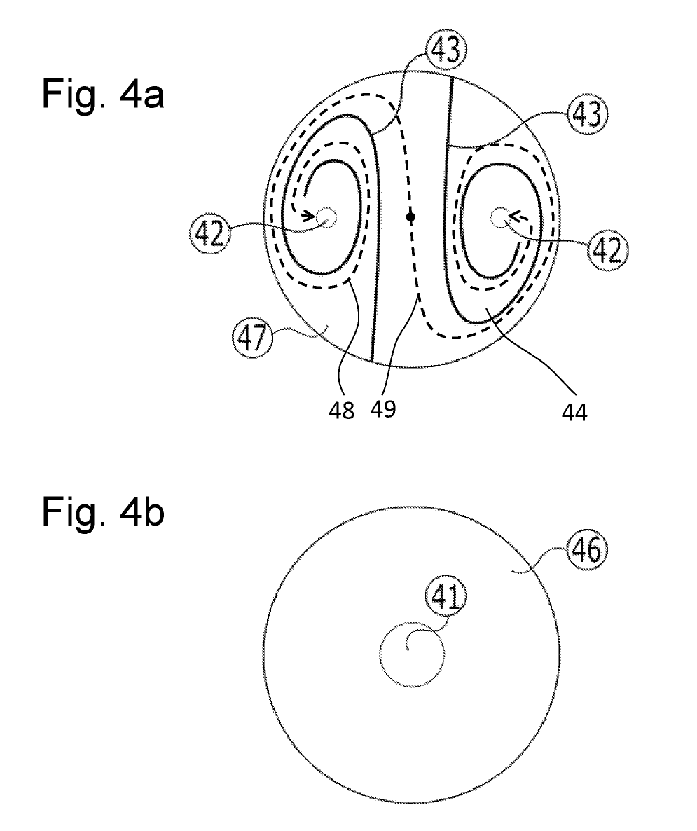

FIG. 3a shows an alternative maze 34 which is based on a plurality of elongated deflection elements 33 arranged in parallel. A first flow path 38 for a fluid is formed between an inlet opening 31 and a first outlet opening 32. A second flow path 39 is formed between the inlet opening 31 and a second outlet opening 32. The flow paths comprise linear section which are connected by hairpin turns. Each flow path has a flow path length fl which is longer than the lateral distance d between the inlet opening 31 and the corresponding outlet opening 32. A fluid following the flow path along the deflection elements 33 changes direction at the hairpin turns. As shown in FIG. 3a, the flow path from the inlet opening 31 to the outlet opening 32 includes an approximately 180° counter-clockwise turn, followed by a 180° clockwise turn, a 180° counter-clockwise turn, and another 180° clockwise turn. By adding the absolute angular change of the flow direction, irrespective of the direction of the deflection (clockwise or counter-clockwise), the illustrated path has an absolute angular flow deflection of 4*180°=720°. Advantageously, the directional change of the fluid following the path causes a centrifugal force on contaminants which may thus collect in the hairpin turns of the maze 34. The maze as shown in FIG. 4a has an fl/d ratio of about 15 and a total angular deflection of 720°.

Yet another alternative maze 44 is shown in FIG. 4a. Here, two generally spiral-shaped deflection elements 43 are provided to form a first flow path 48 and a second flow path 49. Each flow path 48,49 has an fl/d ratio of approximately 8.5 and an absolute angular deflection fd of approximately 630°. The spiral-shape deflection elements 43 provide a long and narrow flow path along which a fluid, e.g. a gas, must flow between the inlet opening 41 and the outlet openings 42. The deflection elements 43 may chemically react with the fluid. The large fl/d ratio in that case supports the chemical reaction between the fluid and the gas by exposing the fluid to a large surface area of the deflection element, which is about fl*h with h being the height of the deflection element 43. The fluid may be exposed to both sides of the deflection element, in which case the fluid may be exposed to a deflection element surface area of about 2*fl*h.

What is claimed is:

1. A protective device for a vacuum measuring cell, comprising:
an inlet plate having an inlet opening;
an outlet plate having an outlet opening, the outlet opening being laterally offset from the inlet opening by a lateral distance (d); and
a maze formed by one or more deflection elements extending between the inlet plate and the outlet plate, a flow path for a fluid being formed through the maze from the inlet opening to the outlet opening having a flow path length (fl) and an absolute angular flow deflection (fd) along the flow path,
wherein the flow path length is longer than three times the lateral distance (fl/d>3) and/or the absolute angular flow deflection is greater than 540 degrees)(fd>540°).

2. The protective device as in claim 1,
wherein the one or more deflection elements is a spiral-shaped.

3. The protective device as in claim 1,
wherein the one or more deflection elements are formed from a wire, a band, or a tube.

4. The protective device as in claim 1,
wherein the one or more deflection elements are made of pure metal or a metal alloy and are manufactured or applied by laser melting.

5. The protective device as in claim 1,
wherein the one or more deflection elements are made of plastic or ceramic which is produced or applied by laser sintering.

6. The protective device as in claim 1,
wherein the one or more deflection elements or their surfaces comprises a material which reacts with a gas or its constituents flowing through the maze.

7. The protective device as in claim 6,
wherein the one or more deflection elements or their surfaces comprises at least one of molybdenum, nickel, tungsten, aluminum oxide, and calcium fluoride.

8. The protective device as in claim 7,
wherein the one or more deflection elements has a height (h) and wherein a fluid is exposed to a surface area of the one or more deflection element that is at least fl×h.

9. The protective device as in claim 1,
wherein at least two outlet openings are formed in the outlet plate.

10. The protective device as in claim 1,
wherein the inlet opening is arranged centrally within the inlet plate and
wherein the outlet opening is laterally offset from the center of the outlet plate.

11. A vacuum measuring cell with a protective device as in claim 1,
wherein the protective device is arranged in the vacuum measuring cell such that the inlet plate and the outlet plate are connected at their edge regions to housing walls of the vacuum measuring cell and
wherein a flow path for gas from a gas port into a measuring space of the vacuum measuring cell is formed through the protective device.

12. A protective device for a vacuum measuring cell, comprising:
an inlet plate having an inlet opening;
an outlet plate having
a first outlet opening laterally offset from the inlet opening by a first lateral distance (d1) and
a second outlet opening laterally offset from the inlet opening by a second lateral distance (d2);
a maze formed by one or more deflection elements extending between the inlet plate and the outlet plate;
a first flow path for a fluid being formed through the maze from the inlet opening to the first outlet opening having a first flow path length (fl1) and a first absolute angular flow deflection (fd1) along the first flow path; and
a second flow path for a fluid being formed through the maze from the inlet opening to the second outlet opening having a second flow path length (fl2) and a second absolute angular flow deflection (fd2) along the second flow path,
wherein the first flow path length is longer than three times the first lateral distance (fl1/d1>3) and/or the first absolute angular flow deflection is greater than 360 degrees)(fd1>360°) and
wherein the second flow path length is longer than three times the second lateral distance (fl2/d2>3) and/or the second absolute angular flow deflection is greater than 360 degrees)(fd2>360°).
